(19) United States
(12) Patent Application Publication
(10) Pub. No.: US 2012/0044676 A1
(43) Pub. Date: Feb. 23, 2012

(54) Structure of light-emitting diode (LED) lamp

(75) Inventor: Ching-Huei Wu, San Chung City (TW)

(73) Assignee: Unity Opto Technology Co., Ltd., San Chung City (TW)

(21) Appl. No.: 12/805,768

(22) Filed: Aug. 19, 2010

(51) Int. Cl. F21V 9/00; F21S 4/00

(52) U.S. Cl. 362/231; 362/249.02

(57) ABSTRACT

A structure of color temperature adjustable LED lamp includes a substrate, on which a plurality of cold white light LEDs and a plurality of additional LEDs are respectively mounted. The additional LEDs give off lights having a wavelength of 580-660 nm. The cold white light LEDs give off lights that are mixed with the lights from the additional LEDs to realize adjustment of the result color temperature as desired.

### FIELD OF THE INVENTION

The present invention relates to a structure of lamp, and in particular to a structure of color temperature adjustable light-emitting diode (LED) lamp.

### BACKGROUND OF THE INVENTION

A lighting device is commonly used to improve a space of dim light or a location where light is shielded for ensuring sufficiency of lighting and protecting eyes against poor eyesight or eye diseases, such as myopia, caused by long term insufficiency of lighting. Further, the trend of energy saving and carbon reduction and the invention of light-emitting diodes (LEDs) cause the traditional light sources of tungsten filament bulbs, which consume a large amount of power, to be gradually replaced by LEDs, which are of a small size and consume a minor amount of power.

A conventional LED lighting device is often composed of a circuit board, which carries a plurality of LEDs mounted thereon so that lighting is realized through control of these lighting elements by the circuit board. However, the LED lighting device provides illumination light of which the color temperature is dependent upon the types of LEDs involved. In other words, if the LED contained in the lighting device gives off cold white light, then the illumination realized is cold white light; if the LED used is warm white light, then the illumination would a warm white light illumination. To provide illumination of different color temperature, both cold white light LED, which has a color temperature ranging from 4,000 to 7,000K, and warm white light LED, which has a color temperature ranging from 2,500 to 5,000K, are collectively used and combined in a desired way to adjust the result color temperature. The cold white light LED and the warm white light LED are separate light sources, which are driven separately according to the desired performance of lighting. This raises the related expense and makes the operation troublesome.

Thus, it is desired to provide a structure of LED lamp which is adjustable in respect of the color temperature thereof, in order to make the operation simplified and convenient.

### SUMMARY OF THE INVENTION

An objective of the present invention is to provide a structure of light-emitting diode (LED) lamp that is capable of adjustment of color temperature.

To realize the above objective, the present invention provides a structure of color temperature adjustable LED lamp, which comprises a substrate, a plurality of cold white light LEDs mounted on the substrate, and a plurality of additional LEDs mounted on the substrate. The additional LEDs give off lights having a wavelength of 580-660 nm. The cold white light LEDs give off lights that are mixed with the lights from the additional LEDs. As such, the cold white lights are converted into warm white lights and the result color temperature can be easily adjusted as desired. The use of the cold white light LEDs can be increased, costs lowered, and flexibility of design expanded to thereby realize an advantage of convenience of use.

### BRIEF DESCRIPTION OF THE DRAWINGS

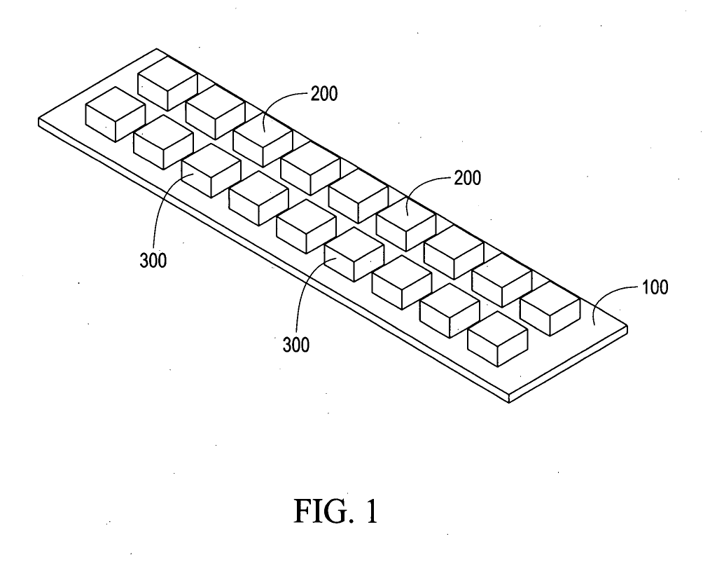

The present invention will be apparent to those skilled in the art by reading the following description of a preferred embodiment thereof with reference to the sole drawing of FIG. 1, which is a schematic view showing a light-emitting diode (LED) lamp constructed in accordance with the present invention.

### DETAILED DESCRIPTION OF THE PREFERRED EMBODIMENT

With reference to the drawings and in particular to FIG. 1, which schematically shows a perspective view of a light-emitting diode (LED) lamp constructed in accordance with the present invention, the LED lamp of the present invention comprises a substrate 100, a plurality of cold white light LEDs 200, and a plurality of second LEDs 300, for adjustment of color temperature of illumination.

The cold white light LEDs 200 and the second LEDs 300 are arranged on the substrate 100 to be parallel to each other or alternate each other in order to have the lights emitting from the cold white light LEDs 200 and lights emitting from the second LEDs 300 to mix with each other so that a desired result of color temperature can be realized through the combination of the lights. The second LEDs 300 can be for example red LEDs, orange LEDs, or red/orange LEDs, and the second LEDs 300 give off lights of a wavelength in the range of 580-660 nm.

In the embodiment illustrated, the substrate 100 carries a plurality of cold white light LEDs 200 and a plurality of second LEDs 300 that are mounted thereon and the cold white light LEDs 200 and the second LEDs 300 are arranged parallel to each other. The second LEDs 300 are red/orange LEDs. The cold white light LEDs 200 emit cold white lights that are mixed with the lights emitting from the second LEDs 300 so as to convert the cold white lights into warm white lights. The structure of the LED lamp according to the present invention is simple and adjustment of color temperature of the resultant light can be realized without de-activating or turning off the cold white light LEDs 200 that are present on the substrate 100.

In summary, the present invention provides a structure of LED lamp, which comprises a substrate 100 on which a plurality of cold white light LEDs 200 and a plurality of addition LEDs 300 are mounted. The additional LEDs 300 give off lights of a wavelength of 580-600 nm for mixing with the lights emitting from the cold white light LEDs 200. In this way, the result color temperature can be easily adjusted without de-activating the cold white light LEDs 200 and the use of the cold white light LEDs is increased, which leads to lowering of costs and expanded flexibility of design, eventually realizing an advantage of convenience of use.

Although the present invention has been described with reference to the preferred embodiment thereof, it is apparent to those skilled in the art that a variety of modifications and changes may be made without departing from the scope of the present invention which is intended to be defined by the appended claims.

What is claimed is:

1. A light-emitting diode (LED) lamp, comprising:
a substrate;
a plurality of cold white light LEDs, which is mounted on the substrate; and
a plurality of additional LEDs, which is mounted on the substrate and give off lights having a wavelength of 580-600 nm, whereby the cold white light LEDs give off lights that are mixed with the lights from the additional LEDs.

2. The LED lamp as claimed in claim 1, wherein the additional LEDs comprise one of red LED and orange LED.

3. The LED lamp as claimed in claim 1, wherein the cold white light LEDs and the additional LEDs are arranged parallel to each other on the substrate.

4. The LED lamp as claimed in claim 1, wherein the cold white light LEDs and the additional LEDs are alternating each other on the substrate.
